(19) United States
(12) Patent Application Publication
(10) Pub. No.: US 2012/0002622 A1
(43) Pub. Date: Jan. 5, 2012

(54) METHOD FOR SIGNAL SPACE PARTITION AND ASSIGNMENT AND APPARATUS USING THE SAME

(75) Inventors: Ravishankar H. MAHADEVAPPA, San Jose, CA (US); Kiran ULN, Pleasanton, CA (US); Thomas E. PARE, JR., Mountain View, CA (US)

(73) Assignee: Ralink Technology (Singapore) Corporation PTE. LTD., Singapore (SG)

(21) Appl. No.: 13/175,722

(22) Filed: Jul. 1, 2011

Related U.S. Application Data
(60) Provisional application No. 61/361,343, filed on Jul. 2, 2010.

(51) Int. Cl. H04W 72/04; H04W 4/00

(52) U.S. Cl. 370/329; 370/328

(57) ABSTRACT

A method and system utilized in a wireless communication system is disclosed. The communication system includes a transmitter and one or more of stations in communication therewith. The method and system comprise encoding a data assignment of each of the data streams associated with a packet into a plurality of bits, wherein the plurality of bits are within a header of the packet within the transmitter. The method and system also includes decoding the plurality of bits by the one or more stations to allow the one or more stations to obtain the appropriate data stream.

### CROSS-REFERENCE TO RELATED APPLICATIONS

This application claims the benefit of U.S. Provisional Application No. 61/361,343, filed on Jul. 2, 2010, entitled “METHOD FOR SIGNAL PARTITION AND ASSIGNMENT AND APPARATUS USING THE SAME,” which is incorporated herein by reference in its entirety.

### FIELD OF THE INVENTION

The present invention relates to a method for signal space partition and assignment and apparatus using the same, more particularly, to a method for signal space partition and assignment and apparatus using the same in wireless communications.

### BACKGROUND OF THE INVENTION

A wireless transmitter possessing a plurality of transmit antennas can simultaneously transmit a plurality of data streams using different spatial or space-time dimensions. The exact number of streams may be decided by the transmitter based on channel conditions, capabilities of the intended receiver or receivers, and any additional space-time coding applied on the data streams. In a packet based communication system, a portion of each packet, which may be called SIGNAL field, provides information necessary at the station to decode the rest of the packet. When multiple data streams intended for multiple stations, are simultaneously transmitted in a single packet, the number of streams assigned to each station and the number of stations the packet is intended to reach has to be provided in the SIGNAL field.

Therefore, a method for simultaneous transmission of data streams to multiple stations using different spatial or space-time streams has to be addressed. A conventional solution to communicate the required information may include providing a list of number of streams in the SIGNAL field. However, this process requires more bits and hence is not efficient. So there's a need for a method for communicating number of data streams assigned to multiple stations and the identification of intended stations within a packet in a compact and efficient manner.

### SUMMARY OF THE INVENTION

A method and system utilized in a wireless communication system is disclosed. The communication system includes a transmitter and one or more of stations in communication therewith. The method and system comprise encoding a data assignment of each of the data streams associated with a packet into a plurality of bits, wherein the plurality of bits are within a header of the packet within the transmitter. The method and system also includes decoding the plurality of bits by the one or more stations to allow the one or more stations to obtain the appropriate data stream.

### BRIEF DESCRIPTION OF THE DRAWINGS

The accompanying drawings illustrate several embodiments of the invention and, together with the description, serve to explain the principles of the invention. One skilled in the art will recognize that the particular embodiments illustrated in the drawings are merely exemplary, and are not intended to limit the scope of the present invention.

FIG. 1A illustrates a wireless communication system capable of transmitting multiple data streams simultaneously.

FIG. 1B is a flow chart of a method in accordance with the present invention.

FIG. 2 is a table that lists a fixed number of partitions of data streams.

FIG. 3 is a table that lists the number of partitions, wherein the number of streams is less than four (4) by fixing the number of stations N_{STA}.

FIG. 4 is a table that illustrates the grouping of partitions.

FIG. 5 is a table that illustrates an additional constraint, that when N_{STA}>1, and N_{STS,k}<14.

### DETAILED DESCRIPTION

The present invention relates to a method for signal space partition and assignment and apparatus using the same, more particularly, to a method for signal space partition and assignment and apparatus using the same in wireless communications. The following description is presented to enable one of ordinary skill in the art to make and use the invention and is provided in the context of a patent application and its requirements. Various modifications to the preferred embodiment and the generic principles and features described herein will be readily apparent to those skilled in the art. Thus, the present invention is not intended to be limited to the embodiment shown but is to be accorded the widest scope consistent with the principles and features described herein.

It is therefore an object of the present invention to provide a method for providing compact presentation of the information to be conveyed to all the intended stations.

It is therefore another object of the present invention to provide an apparatus for providing compact presentation of the information to be conveyed to all the intended stations.

A system and method in accordance with the present invention encodes a stream assignment in a communication system into a header of a packet at transmitter. One or more stations can then decode the streams assignment from the header to allow each of the stations to obtain the appropriate data streams.

A system that utilizes a encoding/decoding procedure in accordance with the present invention can take the form of an entirely hardware implementation, an entirely software implementation, or an implementation containing both hardware and software elements. In one implementation, this detection procedure is implemented in software, which includes, but is not limited to, application software, firmware, resident software, microcode, etc.

Furthermore, the encoding/decoding procedure can take the form of a computer program product accessible from a computer-usable or computer-readable medium providing program code for use by or in connection with a computer or any instruction execution system. For the purposes of this description, a computer-usable or computer-readable medium can be any apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk, and an optical disk. Current examples of optical disks include DVD, compact disk-read-only memory (CD-ROM), and compact disk-read/write (CD-R/W). To describe the features of the present invention in more detail, refer now to the following description in conjunction with the accompanying Figures.

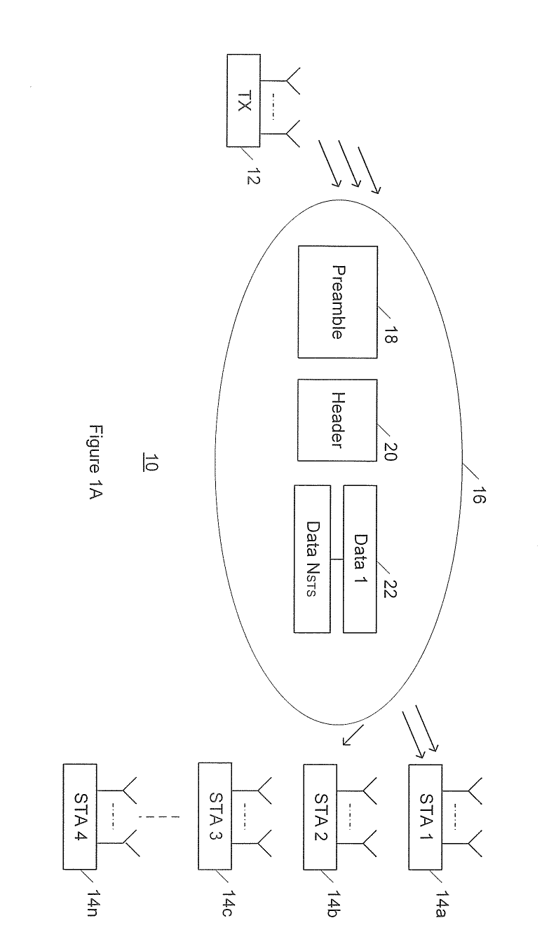

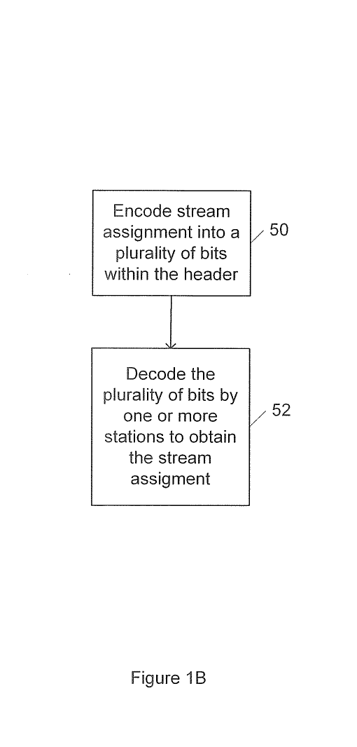

FIG. 1A illustrates a wireless communication system 10 capable of transmitting multiple data streams simultaneously. The wireless communication system 10 comprises a transmitter 12 and a plurality of stations 14a-14n. In the wireless communication system 10, one or more packets 16 containing a preamble 18, header 20 and data 22 are exchanged between the transmitter 12 and stations 14a-14n devices. The header 20, sometimes referred to as the SIGNAL field, contains information such as modulation, code rate and length necessary for decoding the data field. With multiple transmitting antennas, a plurality of independent data streams may be transmitted in a single packet 16 to several stations 14a-14n. In such packets 16, the header 20 also needs to specify which streams are assigned to which station 14a-14n, such that the station 14a-14n can decode those particular data streams successfully.

FIG. 1B is a flow chart of a method for encoding/decoding the packets 16 in a data stream in accordance with the present invention. Referring to FIGS. 1A and 1B together, first a stream assignment is encoded into a plurality of bits, wherein the plurality of bits are included in the header 20 of the packet 16 at the transmitter 12, via step 50. Thereafter the encoded plurality of bits are decoded by the one or more stations 14a-14n to obtain the stream assignments, via step 52.

Transmitted streams are sometimes referred to as space-time streams and the number of streams may be denoted by N_{STS}. Each space-time stream may be derived from a spatial stream by encoding symbols across antennas as well as time dimensions. In general, the number of spatial streams (N_{SS}) satisfies the condition N_{SS}≦N_{STS}. In addition, the number of intended stations 14a-14n for a particular packet 16 Ns_{TA} may also satisfy the condition that N_{STA}≦N_{SS}.

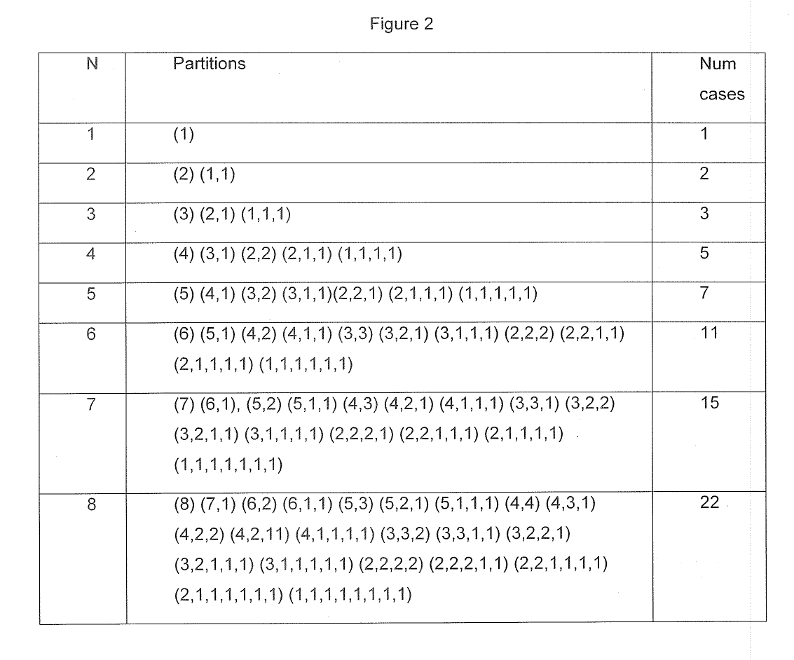

Given N_{STS} and N_{STA}, the transmitter 12 may decide how to split N_{STS} streams among the stations 14a-14n based on several criteria including channel conditions, stations 14a-14n capabilities and overall throughput considerations. For example, if N_{STS}=3 and N_{STA}=2, the transmitter 12 may indicate a partition of (2,1) which means two streams are addressed to station 14a and one stream is addressed to station 14b. For values of N_{STS}=1, 2, . . . , 8, there are a fixed number of such partitions as listed in the table of FIG. 2.

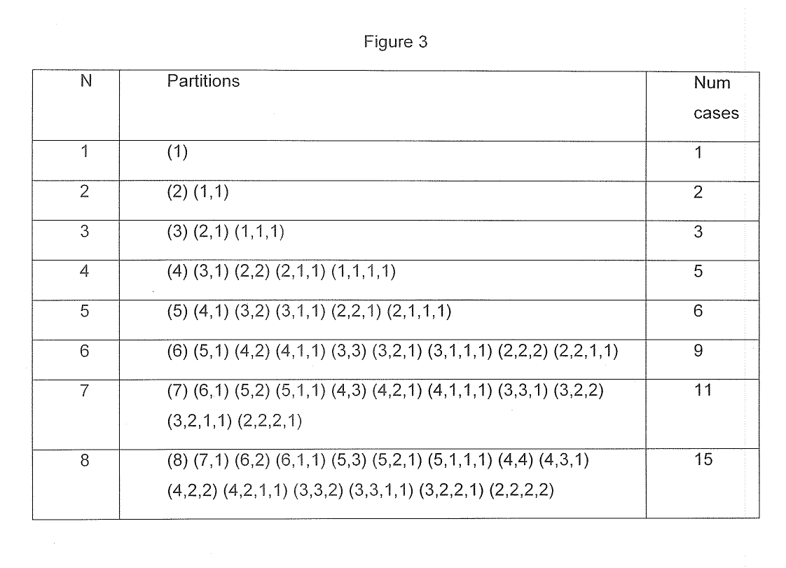

In practice, there may be several conditions imposed on the system 10 in order to limit complexity, such as a hard limit on the number of stations 14a-14n simultaneously supported. For example, with the condition N_{STA}≦4, the transmitter 12 has fewer valid partitions to choose from, as shown in the table of FIG. 3.

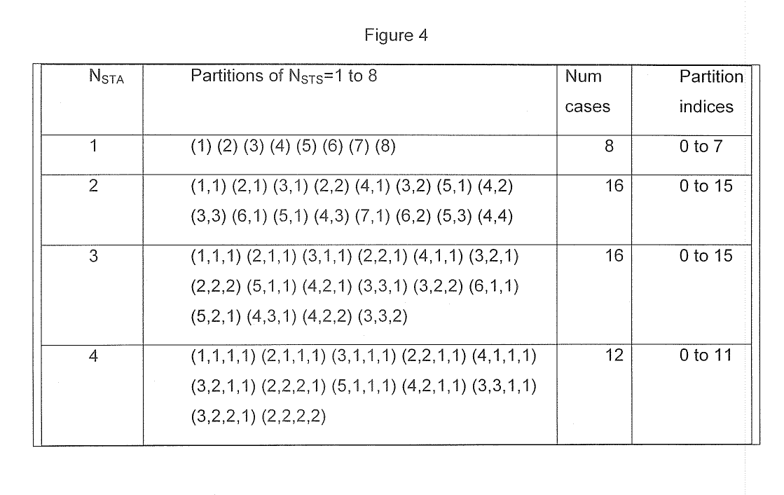

Another way of grouping the partitions is to fix the number of stations 14a-14n. The resulting set of partitions is shown in the table of FIG. 4.

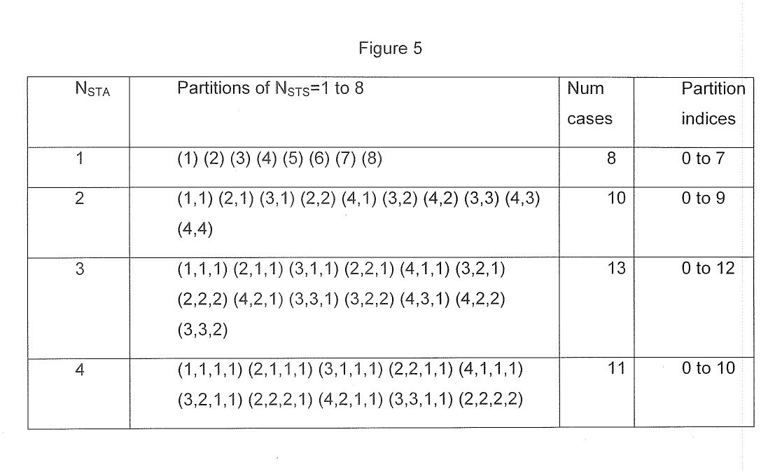

More generally, the transmitter may be choosing a partition from a subset of all possible partitions shown in FIG. 4, when there are additional constraints. For example, an additional constraint could be that when N_{STA}>1, then N_{STS,k}≦4. With that, the number of valid partitions is further reduced as shown in the table of FIG. 5.

According to another embodiment of the present invention, when a particular packet 16 is to be transmitted, the transmitter 12 fixes N_{STS} and N_{STA}, and then chooses a valid partition. This information has to be also placed in the header 20, so that the stations 14a-14n can use it to decode the relevant streams successfully.

For the purposes of illustration, assume that N_{STA}≦4, N_{STS}≦8 and that each station 14a-14n has an ID, called STA_PHY_ID, associated with it, and it can be represented using NID bits. In this illustration, NID=5.

According to an embodiment of the present invention, the header 20 contains the following fields:

[STA_PHY_ID₁, STA_PHY_ID₂, STA_PHY_ID₃, STA_PHY_ID₄, PI_NSTS, PI_NSS]

There may be additional fields in the header 20 to convey other information.

The STA_PHY_IDₙ is used by the stations 14a-14n to check whether there are any streams addressed to it. If field STA_PHY_IDₙ is set to 0, it may be assumed that N_{STA}=n−1, that is, the packet 16 has data for n−1 stations 14a-14n whose IDs are given STA_PHY_ID₁ through STA_PHY_IDₙ₋₁. Thus the stations 14a-14n can also derive N_{STA} from these fields.

PI_NSTS is the index of the partition of N_{STS} used. Since the station 14a-14n can derive N_{STA} from STA_PHY_ID fields as described in the previous paragraph, the table of FIG. 5 can be used to index the partitions. For example if N_{STA}=2, N_{STS}=4 and the partition is (3,1), the index to be transmitted is 2. In row 2 of the table of FIG. 5, the partition (3,1) is the third entry, so assuming the index starts with 0, index 2 for partition (3,1) is obtained. Since the maximum value for the index is 15 (16 cases represented by 0-15), 4 bits can be allocated for PI_NSTS.

Similar to PI_NSTS, the parameter PI_NSS may be derived from the table of FIG. 5. Further constraints may be imposed by the transmitter 12 resulting in a reduction in the number of cases to be encoded. For this example, assuming no further constraints and N_{SS}=3, with partition (2,1), PI_NSS=1. Since the maximum value for PI(NSS) is also 15, 4 bits can be allocated for PI(NSS).

Thus a compact representation of the stream assignment using N_{ID} N_{STA}+N_{PI}_{_{—}}_{NSTS}+N_{PI}_{_{—}}_{NSS} bits can be obtained, which for the current embodiment is 5×4+4+4=28 bits. Note that of 28 bits, 20 bits are used for conveying identifiers and just 8 bits convey the stream partition information.

According to another embodiment, the header 20 contains the following fields:

[GROUPID, PI_NSTS, PI_NSS]

Here the GROUPID is an index to a table listing various groups of stations. The identities of intended stations 14 can be derived from the table of FIG. 5 given the index to the desired group. As in the previous embodiment, the partition indices PI_NSTS and PI_NSS provide the stream assignment.

Alternative methods which do not use the partition index method as outlined above require more bits to transmit the stream assignment information. One simple method would be to list the number of streams for each user as follows:

[. . . ,N_{STS},₁, N_{STS},₂, N_{STS},₃, N_{SS},₁, N_{SS},₂, N_{SS},₃, N_{SS},₄]

This format requires 4×3+4×3=24 bits to convey all possible combinations of N_{STS} and N_{SS} for each of the 4 stations 14a-14n, assuming N_{STS}, N_{SS}=8 which requires 3 bits allocation for each station 14. The previous two embodiments using the partition index required just 8 bits to convey the same information. Since every packet 16 will be required to carry this information, significant savings in bandwidth is achieved by employing the partition index methods.

The transmitter 12 and the stations 14a-14n each maintain look-up tables similar to FIG. 5, which may be fixed or dynamically updated based on additional constraints. Updates to the figures are assumed to be communicated to all the devices participating in the data exchange process. Encoding is then done at the transmitter 12 by looking up the correct index given a partition and inserting the index bits in the header 20 as described earlier. At the stations 14a-14n the index bits are extracted from the header 20 and mapped to the correct partition using a copy of the same look-up table. The partition is then used to identify the number of data streams the stations 14a-14n should expect to decode from the remaining relevant parts of the packet 16.

Although the present invention has been described in accordance with the embodiments shown, one of ordinary skill in the art will readily recognize that there could be variations to the embodiments and those variations would be within the spirit and scope of the present invention. Accordingly, many modifications may be made by one of ordinary skill in the art without departing from the spirit and scope of the appended claims.

What is claimed is:

1. A method utilized in a wireless communication system, the communication system including a transmitter and one or more of stations in communication therewith, the method comprising:
encoding a data stream assignment of each of the data streams associated with a packet into a plurality of bits, wherein the plurality of bits are within a header of the packet within the transmitter; and
decoding the plurality of bits by the one or more stations to allow the one or more stations to obtain the appropriate data stream.

2. The method of claim 1, wherein the transmitted data streams comprise space-time streams and/or spatial streams.

3. The method of claim 1, wherein the data streams are partitioned among the stations based upon at least one criteria.

4. The method of claim 3, wherein conditions may be imposed to minimize complexity when partitioning the stations.

5. The method of claim 4, wherein the conditions include minimizing the number of data streams that can be associated with a station.

6. The method of claim 1, wherein there are additional fields within the header to include a plurality of fields, wherein one field is used by the stations to check whether there are any streams addressed to station, wherein another field is used to index the partition of each data stream.

7. The method of claim 1, wherein the header can include a field related to the group ID of the one or more stations.

8. A computer readable medium utilized in a communication system, the communication system including a transmitter and one or more of stations in communication therewith, the computer readable medium including program instructions executed on a computer, the program instructions comprising:
encoding a data stream assignment of each of the data streams associated with a packet into a plurality of bits, wherein the plurality of bits are within a header of the packet within the transmitter; and
decoding the plurality of bits by the one or more stations to allow the one or more stations to obtain the appropriate data stream.

9. The computer readable medium of claim 8, wherein the transmitted data streams comprise space-time streams and/or spatial streams.

10. The computer readable medium of claim 8, wherein the data streams are partitioned among the stations based upon at least one criteria.

11. The computer readable medium of claim 10, wherein conditions may be imposed to minimize complexity when partitioning the stations.

12. The computer readable medium of claim 11, wherein the conditions include minimizing the number of data streams that can be associated with a station.

13. The computer readable medium of claim 8, wherein there are additional fields within the header to include a plurality of fields, wherein one field is used by the stations to check whether there are any streams addressed to station, wherein another field is used to index the partition of each data stream.

14. The computer readable medium of claim 8, wherein the header can include a field related to the group ID of the one or more stations.
